(19) United States
(12) Patent Application Publication
(10) Pub. No.: US 2011/0147306 A1
(43) Pub. Date: Jun. 23, 2011

(54) USE OF CATIONIC COAGULANT AND ACRYLAMIDE POLYMER FLOCCULANTS FOR SEPARATING OIL FROM OILY WATER

(75) Inventors: David M. Polizzotti, Yardley, PA (US); Abdul Rafi Khwaja, Lansdale, PA (US)

(73) Assignee: GENERAL ELECTRIC COMPANY, Schenectady, NY (US)

(21) Appl. No.: 12/641,528

(22) Filed: Dec. 18, 2009

(51) Int. Cl. B01D 17/05; B01D 21/01; B01D 17/038; B01D 21/26

(52) U.S. Cl. 210/638; 210/728; 210/708

(57) ABSTRACT

Methods for treating oily wastewater comprising adding to the wastewater a cationic coagulant and an acrylamide copolymer flocculant. The acrylamide copolymer flocculant may comprise either an anionic acrylamide copolymer flocculant or a cationic acrylamide copolymer flocculant or both. The acrylamide flocculants may be present in an emulsion or mixture along with activated starch or maleamate derivatized starch. The method may be employed, for example, to clarify SAGD and/or frac produce waters.

### FIELD OF INVENTION

The present invention relates to methods of deoiling oily water including process waters obtained from oil sands mining and other oil and gas recovery operations. More particularly, the invention relates to processes in which a cationic coagulant is employed conjointly with an acrylamide polymer flocculant to clarify the oily wastewater.

### BACKGROUND OF THE INVENTION

Steam assisted gravity drainage (SAGD) methods are commonly employed as an oil recovery technique for producing heavy crude oil and bitumen, especially in oil sands projects. In this method, two parallel horizontal wells are drilled. The upper well injects steam into the geological formation, and the lower well collects the heated crude oil or bitumen that flows out of the formation along with water from the condensation of the injected steam. This condensed steam and oil are pumped to the surface wherein the oil is separated, leaving an oily/water mixture known as “produce water”. Roughly three barrels of this oily and bituminous containing process water are produced per barrel of recovered oil. Recovery and reuse of the water are needed to reduce operational costs and to minimize environmental concerns. The process water is eventually recycled to the steam generators used in the SAGD process, but it must first be clarified and separated from suspended and emulsified oil and bitumen as well as salts and other impurities.

The SAGD produce water normally contains about 1-60% solids and has a temperature of about 95° C. It has accordingly required energy intensive evaporators to provide for effective reuse of this SAGD produced water.

Additionally, hydraulic fracturing or fracing may be used to initiate natural gas production in low permeability reservoirs and to restimulate production in older wells. These processes produce millions of gallons of so-called frac water. Once the fracturing is complete, the frac water is contaminated with petroleum residue and is returned to holding tanks for decontamination. Light non-aqueous phase liquids may be separated from the frac water via separation leaving an underlying contaminated frac water containing oily residue that must be separated prior to discharge of the water in an environmentally acceptable manner.

### BRIEF DESCRIPTION OF THE INVENTION

A method for treating oily water is provided comprising adding to the oily water a cationic coagulant and an acrylamide copolymer flocculant. The so-treated oily water is then subjected to a mechanical separation process such as filtration, reverse osmosis, cyclonic action, flotation, gravity separation, and Voraxial separation techniques.

In one aspect of the invention, the oily water comprises SAGD or frac produce water, and the water is clarified by subjecting it to centrifugal separation techniques such as may be performed in a Voraxial® separation device available from Environ Voraxial Technology, Fort Lauderdale, Fla. The cationic coagulant and an acrylamide copolymer flocculant are added to the influent water admitted to the Voraxial® centrifugal separator.

In another exemplary embodiment, the cationic copolymer is a poly EPI/DMA copolymer. Further, in other embodiments, the acrylamide copolymer can comprise either a cationic acrylamide copolymer or an anionic acrylamide copolymer or both the cationic acrylamide copolymer and anionic acrylamide copolymer may be used. In one embodiment, a cationic acrylamide copolymer is utilized as the flocculant, and this cationic flocculant has a cationic monomeric repeat unit comprising allyltrialkylammonium chloride, diallyl dialkylammonium chloride, or ammonium alkyl(meth)acrylate. These cationic acrylamide copolymer flocculants may have a molecular weight of at least one million and an acrylamide monomer content of at least 50% (molar). In another exemplary embodiment, the cationic acrylamide flocculant may be combined in mixture or emulsion form with an activated starch or maleamate derivatized starch.

In another aspect of the invention, the acrylamide flocculant is an anionic acrylamide flocculant, such as an acrylamide/acrylic acid or acrylamide/acrylate copolymer. In some instances, the anionic acrylamide flocculant may be present in a mixture or emulsion wherein activated starch or maleamate derivatized starch is also present as a component.

### BRIEF DESCRIPTION OF THE DRAWING

FIG. 1 is a schematic cross sectional view of a Voraxial separator that may be used in one embodiment of the invention.

### DETAILED DESCRIPTION OF THE INVENTION

In one aspect of the invention, a cationic coagulant is added to the oily water, such as produce water from SAGD processes. In another exemplary embodiment, the oily water is pH adjusted via addition of HCl or the like to a pH of 2-7. A cationic coagulant is added in an amount of about 0.5-1,000 ppm, and in another embodiment, the pH of the oily water is adjusted to a pH of from about 3 to 10.

In another exemplary embodiment, a flocculant, such as an acrylamide flocculant, is fed to the oily water in a dosage range of about 0 to 200 ppm. In another embodiment, an additional flocculant is added in an amount of 0 to 200 ppm.

In another aspect of the invention, the so-treated oily water is fed to the upstream, influent end of a Voraxial® oil separator of the type described in U.S. Pat. No. 5,084,189 or 6,248,231. The coagulant and flocculants enter the Voraxial oil separator as pin floc, and the floc grows in size as the water passes through the oil separator tube. The coagulants and flocculants break the oil emulsion, thus leading to an improved separation of oil from water. The central tube in the Voraxial separator collects the oil, and the clean water passes through the unit as effluent. The high specific gravity solids and suspended flocculated matter exits the apparatus at a circumferential tube location.

As per the above, in one aspect of the invention, a coagulant is fed to the oily wastewater. This coagulant is preferably a cationic coagulant formed via reaction of an epoxy reactant such as epichlorohydrin and a secondary amine such as dimethylamine. These polymers are detailed in U.S. Reissue Pat. 28,807 and are referred to generally as polyquaternary polymers formed from reaction of a secondary amine and a difunctional epoxide.

Other exemplary cationic coagulants may be mentioned and include cationic acrylamide copolymers which, in addition to polymeric repeat units based on acrylamide, can comprise cationic monomeric repeat units based on allyltrialkylammonium monomers such as (DADMAC), i.e., polydiallyldimethyl ammonium chloride, allyl triethyl ammonium chloride, or ammonium alkyl(meth)acrylates. The mole percent of the cationic monomer in the cationic coagulant copolymer is preferably at least 50%, and other monomers, if present, are neutral monomers, e.g., acrylamide. The molecular weight of the polycationic coagulants is preferably at least 5000 and may also range from about 100,000 or more up to about 1,000,000.

In addition to the use of the cationic coagulant, an acrylamide flocculant polymer is employed. This is added with or after the cationic coagulant. The flocculant is a water soluble high molecular weight hydrogen bonding agent which serves to bridge the droplets and bituminous particulates, flocculate them, and bring them quickly out of the solution or emulsion. These acrylamide flocculant copolymers may be anionic flocculants such as acrylamide/anionic copolymers including acrylamide/acrylate copolymers. Additionally, the acrylamide flocculant may be a cationic flocculant including the acrylamide/cationic copolymers such as acrylamide/allyl trialkyl ammonium copolymers. A representative cationic acrylamide copolymer is acrylamide/allyl triethyl ammonium chloride (ATAC) copolymer. Other cationic monomers that can be copolymerized with acrylamide to form a flocculant copolymer include ammonium alkyl (meth)acrylamides, ammonium alkyl (meth)acrylates, and diallyl dialkylammonium salts.

The acrylamide flocculant copolymers generally have about 50-95 mole percent, preferably 70-90 mole percent and more preferably about 80-90 mole percent acrylamide residue. The molecular weight of these flocculant copolymers is preferably about 1 to 30 million, more preferably 12 to 25 million, and most preferably 15 to 22 million Daltons.

As another flocculant source, activated starch may be mentioned. As mentioned in the published PCT application, WO 2007/047481 and as used herein, “starch” refers to a carbohydrate polymer stored by plants. Common examples are potato, corn, wheat, and rice starch. Starch is in fact a mixture(s) of two polymers: amylose, a linear (1,4)-α-D-glucan, and amylopectin, a branched D-glucan with primarily α-D-(1,4) and about 4% α-D-(1,6) linkages. Native (unmodified) starch is essentially insoluble in water at room temperature.

As is further set forth in WO 2007/047481, the phrase “activated starch” refers to a partially solubilized form of starch prepared by heating starch in water, e.g. in a suspension or spray, preferably at a temperature less than 100° C., e.g., 70-95° C., as described further below. Such activation typically provides flocculation activity not observed in the native (non-activated) starch.

Native starch, e.g., potato starch, corn starch, or wheat starch, is not water-soluble and does not exhibit activity as a flocculant. However, as stated above, it can be modified via an aqueous thermal treatment that renders it partially water-soluble and partially gelled, with some portion generally remaining insoluble. Any starch may be used; however, potato starch is preferred with respect to (its) greater ease of solvation and lower activation temperature in comparison to other starches, such as corn starch and wheat starch. Alternatively, use of other starches such as corn or wheat starch, which are significantly less costly than potato starch, is preferred in cases in which cost is the overriding concern.

Commercially available pregelatinized starch products, in particular ColdSwell™ starch as provided by KMC (Denmark), may also be used. Other commercially available cold water soluble starches that are useful in the formulations and methods disclosed herein include Mira Sperse® 629 corn starch (Tate & Lyle, Decatur, Ill.), NSight™ FG-1 corn starch (Alco Chemical, Chattanooga, Tenn.), and Pregel™ 46 wheat starch (Midwest Grain Products, Atchison, Kans.).

In a typical activation procedure set forth in WO 2007/047481, potato starch is slurried in water at room temperature, preferably at a concentration of about 2 to 4% by weight. The slurry is heated, with vigorous stirring, to about 60-80° C., preferably about 70-80° C., and more preferably 70-75° C., for up to 2 hours, preferably 0.5 to 2 hours. Activation is generally carried out at near-neutral pH, e.g., about 6-7, preferably at slightly acidic pH, e.g., about 6.3 to 6.8. The optimal temperature of activation generally depends on the time of starch being used. For example, in the case of potato starch, as described above, activation begins at approximately 60° C., and inactivation occurs at approximately 85° C. In the case of corn or wheat starch, activation requires heating to 85° C. to 95° C., and inactivation occurs if the material is boiled. These latter types of starches are preferred in applications which may involve exposure to higher temperatures, since they are generally more heat stable than potato starch.

Starch may also be activated via rapid heating, e.g. using steam for brief intervals. Accordingly, the composition is exposed to steam for about 10 seconds to 10 minutes, typically 1-4 minutes, more typically 2-3 minutes. Again, higher temperatures are generally employed for activation of corn and wheat starch than for potato starch. Further details are set forth in WO 2007/047481.

Upon activation, the starch becomes partially solubilized and partially gelled, with some residual micron-sized particulates (visible via light microscopy or atomic force microscopy). Starch activated in this manner is an effective flocculant in itself, particularly in fluids held under relatively static conditions. In one aspect of the invention, the activated starch is added to the oily water in addition to the polyacrylamide polymers referred to above. In one embodiment, the activated starch and acrylamide flocculant are combined in an aqueous mixture or suspension. The activated starch may also be added to the oily water in an amount of about 0.5-200 ppm.

In yet another embodiment, and as reported in WO 2007/047481, a maleamate derivatized polysaccharide, such as a maleamate modified starch may be employed. Derivatization of polysaccharides, such as starch, with maleamic acid is found to enhance flocculant activity. Such derivatization of starch produces a modified starch having pendant secondary amide groups of maleamide. It is believed that the grafted maleamide groups improve flocculation activity by increasing water solubility while retaining or even increasing hydrogen bonding. Other polysaccharides that may be similarly derivatized include, for example, agar, carrageenan, chitosan, carboxymethyl cellulose, guar gum, hydroxyethyl cellulose, gum Arabic, pectin, and xanthan gum.

In one embodiment, starch is derivatized via a Michael addition between the hydroxyl groups of the glucose residues of starch and the double bond of maleamic acid, forming a carbon-to-oxygen (ether) covalent bond. In a typical procedure, a suspension of potato starch at 2 to 4% by weight in water is reacted with an amount of maleamic acid to provide 1 mole of maleamic acid per mole of glucose residue.

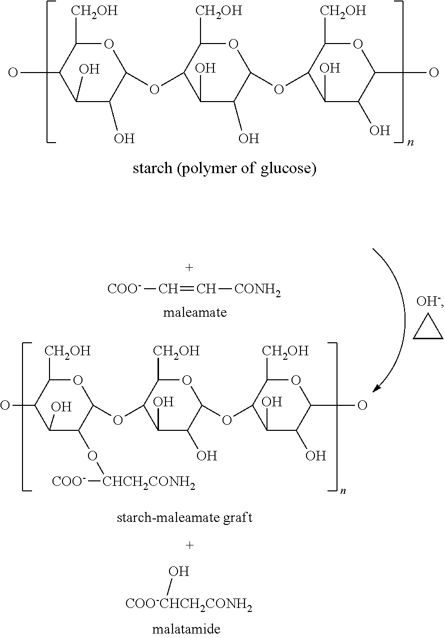

Effective reaction(s) conditions are basic pH, e.g., 9-13, preferably about 12-13, at about 60-125° C., preferably 70-95° C., for about 0.5-3 hours, preferably about 1 hour. A pressure reactor may be used. It is also useful to react higher residue ratios of maleamic acid to glucose, for example up to 3:1, under more alkaline conditions, for example up to pH 13.

The invention will now be further described in conjunction with the following examples, which are to be regarded solely as illustrative and not as restricting the scope of the invention.

### EXAMPLES

In order to demonstrate the efficacy of the inventive treatments in reducing turbidity, Chemical Oxygen Demand (COD), Oil & Grease (O&G), Total Organic Carbon (TOC) and molybdate reactive silica, water clarification tests were conducted on Location A SAGD Produce Water and Location B SAGD Produce Water. These serve as examples, but are not intended to limit the applicability to other similar waters.

### Test Procedure

The procedure used was a standard jar test designed to simulate the operation of a typical produce water treatment clarifier, Dissolved Air Flotation Unit (DAF), Entrapped Air Flotation Unit (EAF), Induced Gas Flotation Unit (IGF) or Density Oil Separator device like the Voraxial oil separator.

For triple component treatments the test procedure consisted of:

(1) Adjusting the pH between 2 to 7

(2) Adding a coagulant (e.g., C1000) to the test substrate

(3) Adjusting the pH between 3 to 10

(4) Adding a cationic flocculant (e.g., C1100)

(5) Adding an anionic flocculant (e.g., A1000).

The substrate was subjected to mixing throughout the chemical addition. Solids were allowed to settle or float after mixing, and the supernatant was analyzed for residual turbidity, COD, Oil & Grease, TOC and molybdate reactive silica. This is an example of the triple component treatment system and does not limit the invention to this procedure.

For two component treatments, the same procedure outlined above was followed. The first was the coagulant C1000, and the other was either a cationic flocculant or an anionic flocculant.

Acids, such as sulfuric acid or hydrochloric acid, and bases, such as sodium hydroxide, may be used to adjust the pH of the produce water.

The coagulant composition is added in any amount effective for agglomerating suspended or soluble oil and grease, organic acids, asphaltenes and suspended solids in produce water. The actual dosage depends upon the characteristics of the produce water to be treated. The coagulant (C1000) composition is added to the produce water in an amount from 0.5 parts per million by volume to about 1000 parts per million by volume. The flocculants may be added in any amount suitable for improving the removal of soluble or suspended oil and grease, organic acids, asphaltenes and suspended solids in produce water. The amount of cationic flocculant (C1100) added is from 0 parts per million by volume to 200 parts per million by volume. The amount of anionic flocculant (A1100) added is from 0 parts per million by volume to 200 parts per million by volume.

### Example 1

Several beakers with 200 ml of Location B SAGD produce water were obtained. The beakers were continuously stirred with paddle mixers. The initial pH of the produce water in the beakers was measured as 8. It was adjusted to a pH of 4 with sulfuric acid. Varying amounts of coagulant C1000 were added in the dosage range from 0 to 100 parts per million by volume. The coagulant was mixed for 60 seconds in all beakers. The pH of the produce water in the beakers was then adjusted to 8.5 with sodium hydroxide. After an additional 30 seconds of mixing, the cationic flocculant C1100 was added to all the beakers at a dosage of 10 parts per million by volume. The cationic flocculant was mixed for an additional 15 seconds and then the anionic flocculant A1100 was added at a dosage of 5 parts per million by volume. The stirring for the produce water was stopped after 2 minutes of total mixing time, and the water was allowed to settle. For untreated produce water, the turbidity was 351 NTU, the COD was 1772 mg/L, the molybdate reactive silica was 112 mg/L. Table 1 contains the efficacy test results for Example 1. The table shows that 35 parts per million by volume of polymer treatment is the most effective dosage for this produce water.

TABLE 1
Results for C1000, C1100, and A1100 polymer treatment
of Location B SAGD Produce Water

| | | Cationic | Anionic | | | | Total |
|---|---|---|---|---|---|---|---|
| | Coagulant | Flocculant | Flocculant | | Molybdate | | Polymer |
| | C1000 parts | C1100 parts | A1100 parts | | Reactive | | parts per |
| | per million | per million | per million | Turbidity | Silica | COD | million by |
| | by volume | by volume | by volume | (NTU) | (mg/L) | (mg/L) | volume |
| 1 | 0 | 10 | 5 | 15 | 90.4 | 1730 | 15 |
| 2 | 5 | 10 | 5 | 5.73 | 85.2 | 1870 | 20 |
| 3 | 20 | 10 | 5 | 4.7 | 87.4 | 1660 | 35 |
| 4 | 50 | 10 | 5 | 60.1 | | | 65 |
| 5 | 80 | 10 | 5 | 56.2 | | | 95 |
| 6 | 100 | 10 | 5 | 106.2 | | | 115 |

C1000 = “AquiClear CL 1000”-available, Aquial LLC, Chesterfield, Mo.; cationic polymer EPI/DMA, mw 100,000~1,000,000.
C1100 = “AquiClear CH 1100”-polysaccharide and cationic polyacrylamide polymer; mixture activated starch:cationic polyacrylamide 1:1 (by weight); cationic polyacrylamide = 80:20 acrylamide/allyl triethyl ammonium chloride mw ≈ 8 million Da.
A1100 = “AquiClear AH 1100”-carbohydrate and polyacrylamide and activated starch mixture 5:2 by weight; polyacrylamide present as acrylamide/acrylate copolymer in molar ratio of (80:20) acrylamide:acrylate mw ≈ 15 million.

### Example 2

Several beakers with 200 ml of Location A SAGD produce water were obtained. The beakers were continuously stirred with paddle mixers. The initial pH of the produce water in the beakers was measured as 6.5. It was adjusted to a pH of 3.5 with sulfuric acid. Varying amounts of coagulant C1000 were added in the dosage range from 0 to 100 parts per million by volume. The coagulant was mixed for 90 seconds in all beakers. The cationic flocculant C1100 was added to all the beakers at a dosage of 15 parts per million by volume. The cationic flocculant was mixed for an additional 15 seconds, and then the anionic flocculant A1100 was added at a dosage of 10 parts per million by volume. The stirring for the produce water was stopped after 2 minutes of total mixing time, and the water was allowed to settle. For untreated produce water, the turbidity was 83.1 NTU, the COD was 1038 mg/L, the molybdate reactive silica was 220 mg/L. Table 2 contains the efficacy test results for Example 2. The table shows that 30 parts per million by volume of polymer treatment is the most effective dosage for this produce water.

TABLE 2
Results for C1000, C1100, and A1100 polymer treatment
of Location A SAGD Produce Water

| | Coagulant | Cationic | Anionic | | | | Total |
|---|---|---|---|---|---|---|---|
| | C1000 | Flocculant | Flocculant | | Molybdate | | Polymer |
| | parts per | C1100 parts | A1100 parts | | Reactive | | parts per |
| | million by | per million | per million | Turbidity | Silica | COD | million by |
| | volume | by volume | by volume | (NTU) | (mg/L) | (mg/L) | volume |
| 7 | 0 | 15 | 10 | 2.43 | 64 | 496 | 25 |
| 8 | 5 | 15 | 10 | 1.38 | 64 | 464 | 30 |
| 9 | 20 | 15 | 10 | 1.8 | 66 | 466 | 45 |
| 10 | 50 | 15 | 10 | 2.22 | | | 75 |
| 11 | 80 | 15 | 10 | 1.97 | | | 105 |
| 12 | 100 | 15 | 10 | 2.61 | | | 125 |

### Example 3

Beakers with 200 ml of Location A SAGD produce water were obtained. The beakers were continuously stirred with paddle mixers. The initial pH of the produce water in the beakers was measured as 7.5. It was adjusted to a pH of 4 with sulfuric acid. Coagulant C1000 was added at the dosage of 20 parts per million by volume. The coagulant was mixed for 105 seconds in the beakers. The anionic flocculant A1100 was then added at a dosage of 20 parts per million by volume. The stirring for the produce water was stopped after 2 minutes of total mixing time, and the water was allowed to settle. The clarified water from several beakers was pooled together for analysis. Table 3 contains the efficacy test results for Example 3 with both the untreated and polymer treated waters.

TABLE 3
Results for C1000, C1100, and A1100 polymer treatment of Location A SAGD product water

| | Anionic | | | | | | | | | | | |
|---|---|---|---|---|---|---|---|---|---|---|---|---|
| Coagulant | Flocculant | | | | Total | | | | | | | |
| C1000 | A1100 | | Molybdate | | Polymer | | | | | | | |
| parts per | parts per | | Reactive | | parts per | Oil & | | % | % | % | % | |
| million by | million by | Turbidity | Silica | COD | million by | Grease | TOC | Removal | Removal | Removal | Removal | |
| volume | volume | (NTU) | (mg/L) | (mg/L) | volume | (mg/L) | (mg/L) | Silica | COD | O&G | TOC | Label |
| 20 | 20 | 5.74 | 64 | 486 | 40 | 7.6 | 124 | 73% | 50% | 99% | 40% | Polymer |
| | | | | | | | | | | | | Treated |
| 0 | 0 | 85.6 | 240 | 970 | 0 | 624 | 207 | — | — | — | — | Untreated |

The oily water treated as per above may then be fed to conventional physical separation processes including flotation, filtration, reverse osmosis, cyclonic, and gravity separation techniques. For example, the treated oily water may be used in conjunction with API separators or entrapped air flotation units (EAF) or induced gas flotation units (IGF) or dissolved air flotation (DAF) techniques wherein a sludge cake is formed and removed, leaving clarified effluent for discharge, with a portion of the effluent recycled to the EAF, IGF, or DAF unit. All such separation processes are referred to as mechanical separation processes.

The treatment may also be used with conventional hydrocyclone separators and centrifugal oil/water separation units such as the Voraxial® brand devices shown in U.S. Pat. Nos. 5,084,189 and 6,248,231. These too are within the ambit of the definition of mechanical separation processes as used herein. In the centrifugal separation process, separation is effected via centrifugal acceleration of the liquid medium by a force vortex spinning action in a tube. The liquid medium is subjected to a swirling or vortex motion in the separator whereby the heavier components are spun along the outer radii of the spinning medium. The lighter fluid is forced by free vortex action and by Bernoulli pressure forces into a tight cylindrical flow along the central axis of the spinning medium. The heavier components (rejects) are separated through a collector trap or the like disposed adjacent the outer periphery of the fluid flow tube.

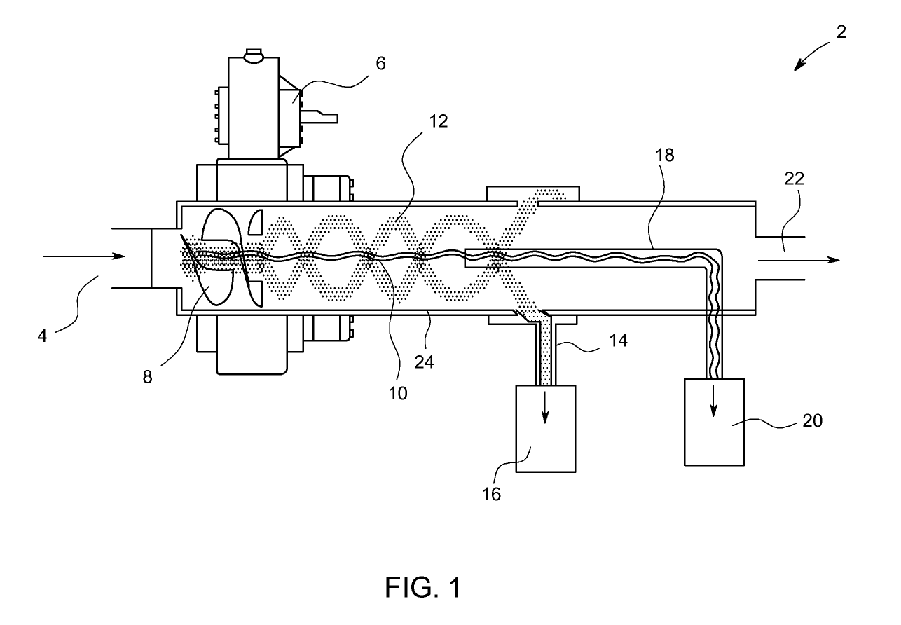

One such Voraxial® separation unit is shown diagrammatically in FIG. 1. Here, Voraxial separator 2 comprises an elongated, enclosed cylindrical housing 24 having an upstream inlet 4 and downstream outlet 22. A Voraxial drive unit 6 is operatively connected to a plurality of blade members 8 to impart rotation thereto to create a centrifugal acceleration force to the fluid medium fed to the housing as it travels from an upstream direction from the inlet 4 to the outlet 22. The rotating blades 8 cause the medium to spin about the central axis of the housing 24. The fluid is spun and separates into component fluids and solids at different radial locations depending upon the specific gravity thereof.

In the treatment of SAGD and frac product water in the Voraxial separator, the lightest fraction, oil, is forced via free Voraxial action and Bernoulli pressure forces into a tight cylindrical flow as shown at 10 for subsequent separation from the fluid medium through centrally disposed oil collection tube 18 emptying into oil reservoir 20. The heaviest components 12 such as the bitumen and associated solids are collected via a trap 14 located along the circumferential surface of the housing for collection in vessel 16 or the like. The water separated from the oily water fluid medium exits at downstream exit 22 for disposal, recycling into the system or polishing prior to possible use as polished influent water for reverse osmosis membrane treatment. Voraxial separators of the type diagrammatically depicted in FIG. 1 are disclosed for example in U.S. Pat. Nos. 6,248,231 and 5,084,189.

Typical embodiments have been set forth for purposes of illustration of the invention. The foregoing descriptions should not be deemed to be a limitation on the scope herein. It is apparent that numerous other forms and modifications of the invention will occur to one skilled in the art without departing from the spirit and scope herein. The appended claims and these embodiments should be construed to cover all such obvious forms and modifications that are within the true spirit and scope of the present invention.

What is claimed is:

1-5. (canceled)

6. A method as recited in claim 20 wherein said cationic coagulant (I) is a copolymer of epichlorohydrin and a secondary amine.

7. A method as recited in claim 6 wherein said cationic coagulant (I) is poly EPI/DMA.

8-9. (canceled)

10. A method as recited in claim 20 wherein said cationic acrylamide copolymer flocculant is a copolymer of acrylamide/allyltriethylammonium chloride copolymer present in combination with said activated or maleamate derivatized starch.

11. A method as recited in claim 20 wherein said anionic acrylamide copolymer flocculant (III) comprises an anionic monomeric repeat unit comprising acrylic acid or acrylate.

12. A method as recited in claim 11 wherein said anionic acrylamide flocculant (III) is present in combination with an activated starch or maleamate derivatized starch.

13-19. (canceled)

20. A method of separating oil from water in a SAGD or frac produce water of the type having a solids content of from about 1-60%, said method comprising feeding said produce water to a centrifugal separator and adding to said water a treatment composition comprising (I) a cationic coagulant chosen from the group of i) reaction products of epichlorohydrin and a secondary amine and ii) acrylamide cationic copolymers, (II) a cationic acrylamide copolymer flocculant, (III) an anionic acrylamide copolymer flocculant, and (IV) an activated or maleamate derivatized starch flocculant to form a treated water, subjecting said treated water to a swirling, vortex force in said centrifugal separator, and separating said treated water into an oil phase, a water phase, and a sediment phase comprising solids and bitumen, said cationic coagulant being fed to said produce water in an amount of 0.5-1,000 ppm based upon one million parts of said produce water and said II, III, and IV each being added in an amount of up to about 200 ppm, said cationic coagulant having a molecular weight of from about 5,000 to about 1 million Daltons and said cationic acrylamide copolymer flocculant (II) and said anionic acrylamide copolymer flocculant (III) each having a molecular weight of at least one million Daltons.

21. A method as recited in claim 20 wherein said cationic acrylamide copolymer flocculant II has a cationic monomeric repeat unit comprising allyltrialkylammonium chloride, diallyl dialkyl ammonium chloride or ammonium alkyl(meth)acrylate.
